(19) United States
(12) Patent Application Publication
(10) Pub. No.: US 2021/0362307 A1
(43) Pub. Date: Nov. 25, 2021

(54) Motorized Adjustable Wrench

(71) Applicant: Steven J. Anderson, Omaha, NE (US)

(72) Inventor: Steven J. Anderson, Omaha, NE (US)

(21) Appl. No.: 16/878,119

(22) Filed: May 19, 2020

(51) Int. Cl. B25B 21/00; B25B 23/00; B25F 5/02

(52) U.S. Cl. CPC B25B 21/002; B25F 5/02; B25B 23/0007

(57) ABSTRACT

A motorized adjustable wrench is provided. The motorized adjustable wrench may include a wrench head, which wrench head may include a geared wrench having an opening to receive and engage a nut, a geared wrench support mechanism, a plurality of cooperating gears. The motorized adjustable wrench may include a handle portion, which handle portion include a motor in mechanical communication with a drive gear, and a switch. The motorized adjustable wrench may include a plurality of wrench heads, where each of the plurality of wrench heads includes a geared wrench of a different size.

### TECHNICAL FIELD

The present invention generally relates to a motorized adjustable wrench, and, more particularly, to a motorized adjustable wrench configured to fasten and remove nuts.

### BACKGROUND

Wrenches are utilized to facilitate the fastening and removal of threaded nuts to threaded objects, such as bolts and the like. The traditional method of fastening and removing a nut involves the use of a manual wrench. This approach is cumbersome, and, in some cases, impossible using a manual wrench. In addition, the fastening and removal of a nut may be a labor-intensive and time-consuming endeavor. Therefore, it would be desirable to provide an apparatus that cures the shortfalls of the traditional methods.

### SUMMARY

A motorized adjustable wrench is disclosed, in accordance with one or more embodiments of the present disclosure. In one embodiment, the motorized adjustable wrench includes a wrench head. The wrench head may include a geared wrench having an opening configured to receive and engage a nut, a geared wrench support mechanism, and a plurality of cooperating gears in mechanical communication with the geared wrench. In another embodiment, the motorized adjustable wrench may include a handle portion having a motor in mechanical communication with a drive gear, and a switch. In another embodiment, the motorized adjustable wrench may include a plurality of wrench heads, where each of the plurality of wrench heads includes a geared wrench of a different size.

### BRIEF DESCRIPTION OF THE DRAWINGS

FIG. 1 illustrates a motorized adjustable wrench, in accordance with one or more embodiments of the present disclosure.

FIGS. 2A-C illustrate a motorized adjustable wrench, in accordance with one or more embodiments of the present disclosure.

FIG. 3 illustrates a motorized adjustable wrench, in accordance with one or more embodiments of the present disclosure.

FIGS. 4A-4B illustrate a motorized adjustable wrench, in accordance with one or more embodiments of the present disclosure.

FIG. 5 illustrates a motorized adjustable wrench, in accordance with one or more embodiments of the present disclosure.

### DETAILED DESCRIPTION OF THE DRAWINGS

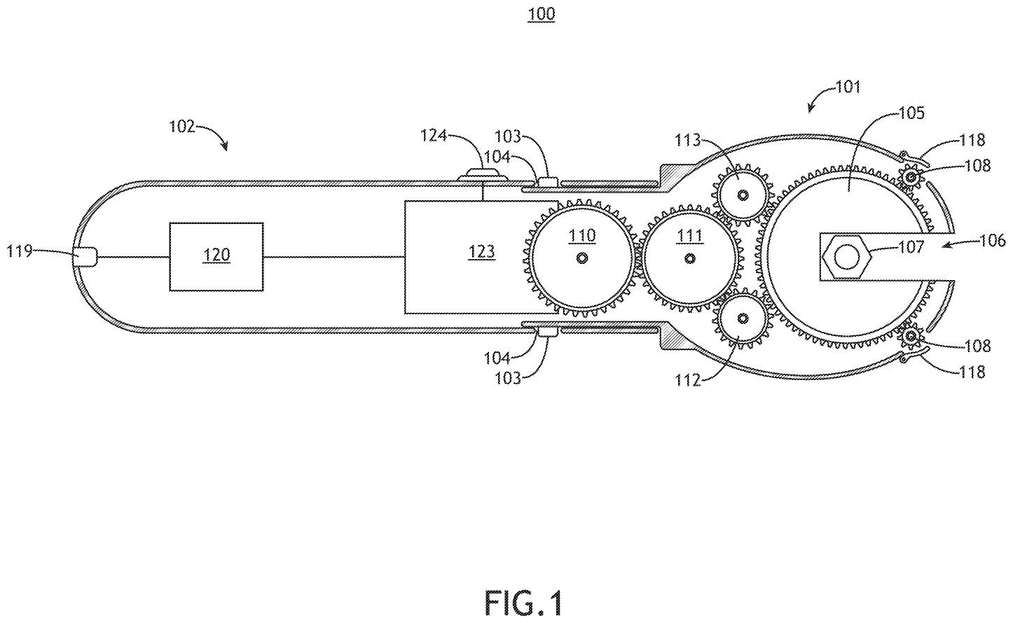

Reference will now be made in detail to the subject matter disclosed, which is illustrated in the accompanying drawings. Referring generally to FIGS. 1 through 5, a motorized adjustable wrench is disclosed, in accordance with one or more embodiments of the present disclosure. The embodiments set forth herein are taken to be illustrative rather than limiting. It should be readily apparent to those of ordinary skill in the art that various changes and modifications in form and detail may be made without departing from the spirit and scope of the present disclosure.

FIG. 1 illustrates a schematic view of a motorized adjustable wrench 100, in accordance with one or more embodiments of the present disclosure. The motorized adjustable wrench 100 may include a wrench head 101 removably coupled to a handle portion 102. The wrench head 101 may be removably coupled to the handle portion 102 via any mechanical means known in the art. For example, the wrench head 101 may be removably coupled to the handle portion 102 via one or more spring clips 103 capable of reversibly engaging one or more holes 104 of the handle portion 102.

The wrench head 101 may be configured as a housing 116, where the housing 116 may be formed from one or more pieces configured to contain the components of the wrench head 101. The wrench head 101 may be formed from any material known in the art to be suitable for the purposes contemplated by the present disclosure. For example, the wrench head 101 may be formed from one or more metals, polymers, and the like. The wrench head 101 may be of a cylindrical, rectangular, ovular, or other shape.

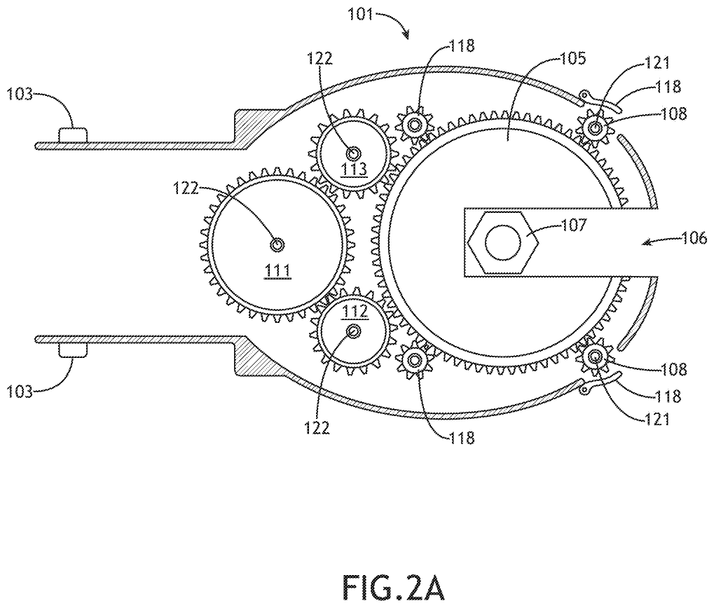

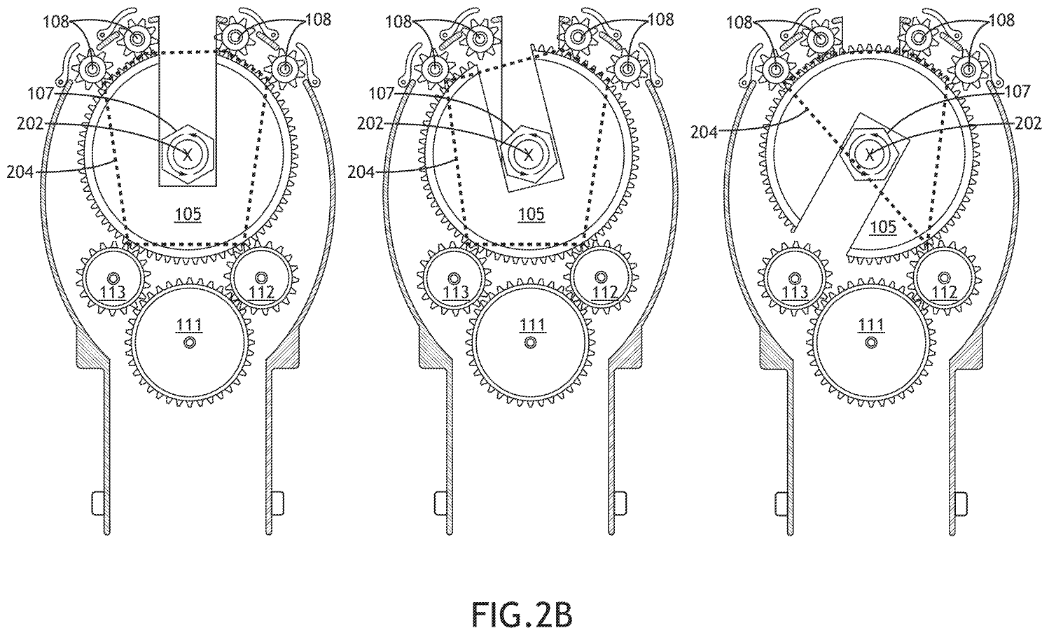

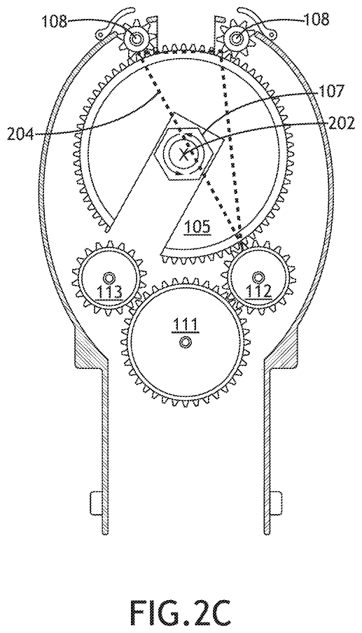

FIG. 2A illustrates a schematic view of the wrench head 101 in accordance with one or more embodiments of the present disclosure. The wrench head 101 may include a geared wrench 105 having an opening 106 configured to receive and engage a nut 107 (e.g., hex nut, square nut, and the like). The opening 106 may correspond to an opening in the housing of the wrench head 101, where the corresponding opening may be of a width similar to the width of the opening 106.

The opening 106 may be of any shape configured to receive and engage the nut 107. For example, the opening 106 may be rectangular in shape and configured to receive and engage either a hex nut or a square nut, where the opening 106 may engage two sides of the hex or square nut. In another embodiment, the opening 106 may include a portion that is hexagonal in shape, where the opening 106 may engage four sides of the hex nut. It is noted that the embodiments of the present disclosure are not limited to receiving a hex nut or a square nut. For example, the opening 106 may be configured to receive and engage an acorn nut, a flange nut, or any other nut known in the art.

The geared wrench 105 The geared wrench 105 may have a rotational axis that corresponds to the rotational axis of the nut 107 when the nut is engaged. The geared wrench 105 is configured to rotationally engage the nut 107 at the opening 106, such that the nut may be rotated about an axis of a bolt or other threaded object.

The wrench head 101 may include two or more free-wheeling gears 108. The free-wheeling gears 108 may be in mechanical communication with one or more axis pins 121 that are configured to support the free-wheeling gears 108 and to permit the free-wheeling gears 108 to rotate about the axis pins 121. The axis pins 121 may be configured to support the free-wheeling gears 108 on a rotational axis that corresponds to the rotational axes of the geared wrench 105 and the nut 107. The free-wheeling gears 108 may rotationally engage the geared wrench 105 such that the free-wheeling gears 108 and the geared wrench 105 rotate in mechanical communication.

The wrench head 101 may include two or more covers 118 configured to allow access to the free-wheeling gears 108. The covers 118 may be hingedly coupled to the wrench head 101 by a hinge. The covers 118 may be configured to permit a user to access the free-wheeling gears, to permit the user to manually rotate the free-wheeling gears 108, and to permit the user to replace the covers 118 over the free-wheeling gears 108. In an alternative embodiment, the covers 118 may be coupled to the wrench head 101 via any means known in the art. For example, the covers 118 may be magnetically coupled to the wrench head 101.

The wrench head 101 may include a plurality of cooperating gears 111-113. The cooperating gears 111-113 may be in mechanical communication with one or more axis pins 122 that are configured to support the cooperating gears 111-113 on a rotational axis that corresponds to the rotational axes of the geared wrench 105 and the nut 107, and to permit the cooperating gears 111-113 to rotate about the axis pins 122. The cooperating gears 112 and 113 may rotationally engage the geared wrench 105 such that the cooperating gears 112 and 113 rotate in mechanical communication with the geared wrench 105. At all times during the operation of the motorized adjustable wrench 100, at least one of cooperating gear 112 and cooperating gear 113 must be in mechanical communication with the geared wrench 105 (i.e., the distance between the cooperating gear 112 and the cooperating gear 113 may not exceed the width of the opening 106). The cooperating gear 111 may be configured to rotationally engage the cooperating gears 112 and 113 such that the cooperating gears 111-113 rotate in mechanical communication.

The wrench head 101 may be configured to include a geared wrench support mechanism. For example, the geared wrench support mechanism may include the relative placement of the free-wheeling gears 108, cooperating gear 112, and cooperating gear 113 such that the free-wheeling gears 108, cooperating gear 112, and cooperating gear 113 provide support for the geared wrench 105.

FIG. 2B illustrates a schematic view of the wrench head 101, in accordance with one or more embodiments of the present disclosure. The geared wrench support mechanism may ensure that, at all times during the operation of the motorized adjustable wrench 100, the geared wrench 105 remains substantially in place and is not prone to slippage within the wrench head 101. For example, the geared wrench support mechanism may be configured such that the axis 202 of rotation of the geared wrench 105, at all times during the operation of the motorized adjustable wrench 100, remains inside the area of a polygon 204 created by connecting each of the free-wheeling gears 108 and the cooperating gears 112-113 that, at a particular time during the operation of the motorized adjustable wrench 100, are in mechanical communication with the geared wrench 105.

FIG. 2C illustrates a scenario in which the geared wrench support mechanism is not configured such that the axis 202 of rotation of the geared wrench 105, at all times during the operation of the motorized adjustable wrench 100, remains inside the area of the polygon 204 created by connecting each of the free-wheeling gears 108 and the cooperating gears 112-113 at a particular time during the operation of the motorized adjustable wrench 100. In this scenario, the geared wrench 105 may be prone to slippage within the wrench head 101, which slippage may compromise the operation of the motorized adjustable wrench 100.

In another embodiment, the geared wrench support mechanism may be configured to ensure that the geared wrench 105 is, at all times during the operation of the motorized adjustable wrench 100, in mechanical communication with at least two of the free-wheeling gears 108. For example, the relative placement of the free-wheeling gears 108, cooperating gear 112, and cooperating gear 113 may vary with the size of the opening 106, such that the distance between any one free-wheeling gear 108 and any one cooperating gear 112-113 is greater than the width of the opening 106.

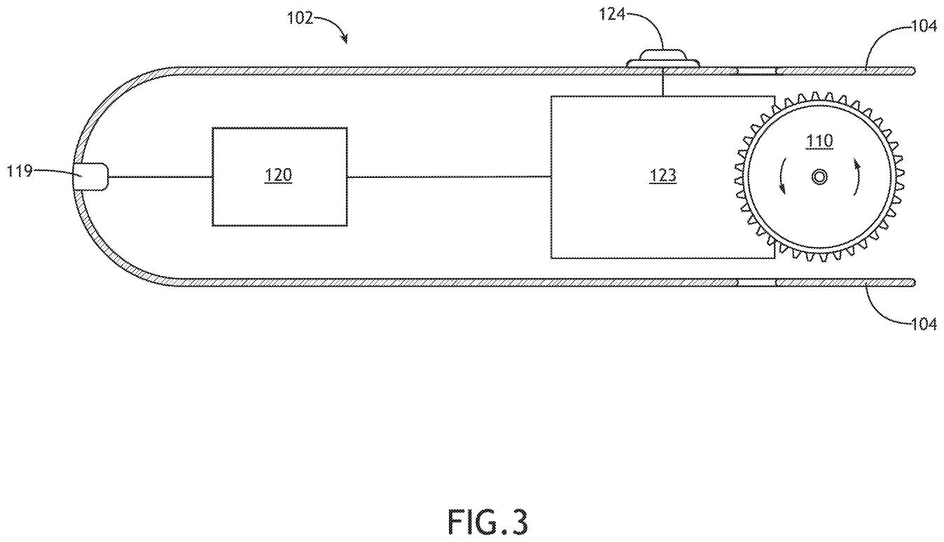

FIG. 3 illustrates a schematic view of the handle portion 102. The handle portion 102 may include a charging port 119, a battery 120, and a motor 123. The charging port 119, the battery 120, and the motor 123 may be in electrical communication via one or more wireline connections (e.g., copper wire, printed circuit board, etc.). The motor 123 may be in mechanical communication with a drive gear 110. The motor 123 may be configured to transfer rotational motion to the drive gear 110. Referring back to FIG. 1, the drive gear 110 may engage the cooperating gear 111 such that the drive gear 110 and the cooperating gear 111 rotate in mechanical communication. In this regard, the motor 123 may be configured to transfer rotational motion to the cooperating gear 111 and the wrenched gear 105. As rotational motion may be transferred to the wrenched gear 105, the wrenched gear 105 may transfer rotational motion to the nut 107, thereby causing the nut 107 to travel about an axis of a threaded object. As the nut 107 travels about the axis of the threaded object, the motorized adjustable wrench may travel about the axis.

The motor 123 may include any electric motor known in the art to be suitable for the purposes contemplated by the present disclosure. For example, the motor 123 may include any AC or DC motor. The motor 123 may include a drive shaft in mechanical communication with the drive gear 110. The drive shaft of the motor 123 may be configured such that the drive shaft may rotate in either a clockwise or a counter-clockwise direction.

The charging port 119 may include any plug-type fitting known in the art to be suitable to provide energy to the motor 123 or for the charging of the battery 120. For example, the charging port 119 may include any port configured to electrically couple at least one of the motor or the battery 120 to an AC or DC power supply.

The battery 120 may include any battery, including, without limitation, a permanent rechargeable battery, known in the art to be suitable for the purposes contemplated by the present disclosure, including, without limitation, for providing energy to the motor 123. For example, the battery 120 may include a lithium ion battery. The battery 120 may be a rechargeable battery configured to be charged via one or more charging ports of the handle portion 102.

The handle portion 102 may include a user-operated switch 124 in electrical communication with the motor 123. The switch 124 may be configured to connect or disconnect one or more paths of electrical current within the handle portion 102. For example, the switch 124 may be configured to connect or disconnect the flow of current from the battery 120 to the motor 123 such that the motor 123 may be configured between an off position and an on position. The switch 124 may be configured to toggle the direction of rotation of the drive shaft of the motor 123. The switch 124 may include any manually operated electromechanical device known in the art. For example, the switch 124 may include a toggle switch.

The handle portion 102 may be formed from any material known in the art to be suitable for the purposes contemplated by the present disclosure. For example, the handle portion 102 may be formed from one or more metals, polymers, and the like. The handle portion 102 may include a housing 116, where the housing 116 may be formed from one or more pieces configured to contain the components of the handle portion 102. The handle portion 102 may be of a cylindrical, rectangular, ovular, or other shape.

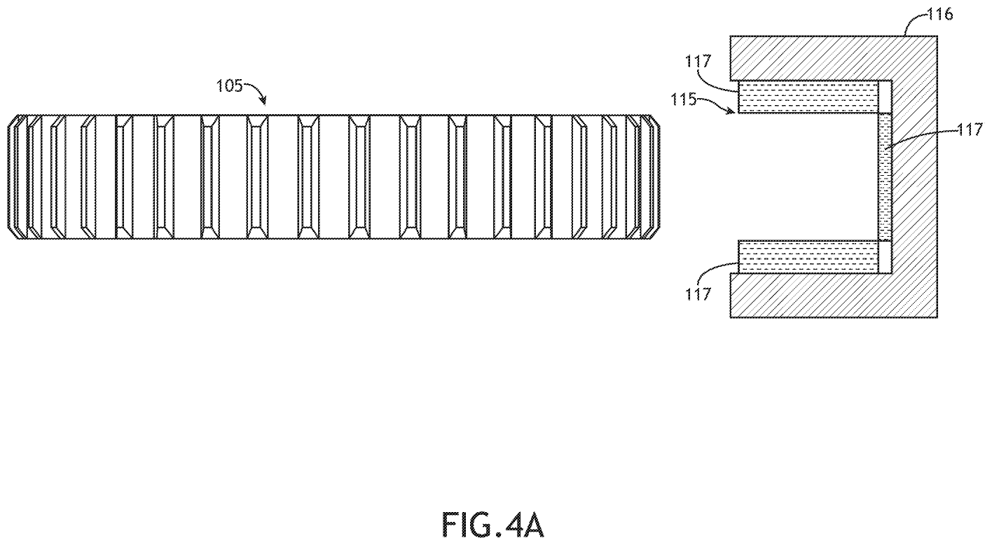

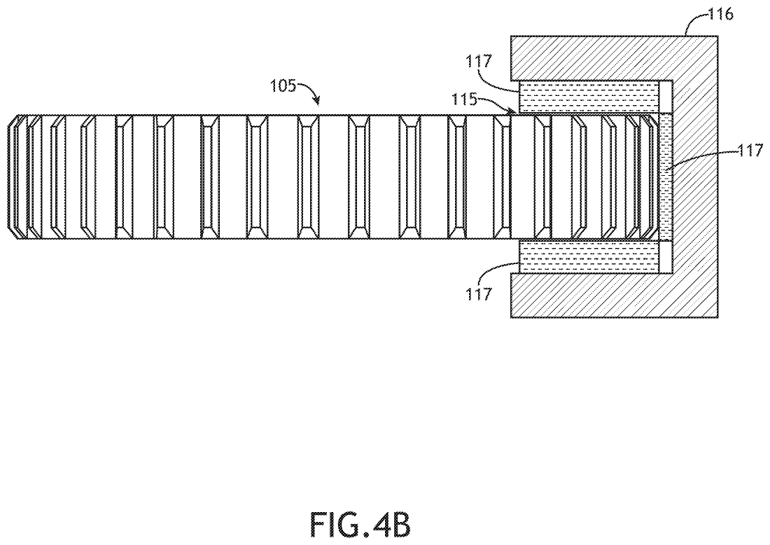

FIG. 4A illustrates an exploded view of a motorized adjustable wrench 100 in accordance with one or more embodiments of the present disclosure. The wrench head 101 and the handle portion 102 may each include one or more channels 115. The one or more channels 115 may be located within the housing 116 of either the wrench head 101 or the handle portion 102, or both. The one or more channels 115 may retain the geared wrench 105. For example, the one or more channels may be configured to abut one or more portions of the geared wrench 105, while permitting the geared wrench 105 to rotate.

FIG. 4B illustrates an assembled view of a motorized adjustable wrench 100 in accordance with one or more embodiments of the present disclosure. One or more pads 117 configured to secure a gear while still permitting rotational motion of the gear may be disposed in the one or more channels 115. For example, the one or more pads 117 may be disposed in the one or more channels 115 of the wrench head 101 to secure the geared wrench 105, the free-wheeling gears 108, and the cooperating gears 111-113, and the one or more pads 117 may be disposed in the one or more channels of the handle portion 102 to secure the drive gear 109, while still allowing the rotational motion of the gears. The pads 117 may be formed from any material known in the art to be suitable for the purposes contemplated by the present disclosure, including, without limitation, any metal or polymer with a low coefficient of friction.

The one or more pads 117 may be configured to ensure that the distance traveled by the gears along an axis within the one or more channels 115 does not exceed a threshold. In this regard, the one or more pads 117 may be of a thickness and size sufficient to maintain the gears within an acceptable area of the one or more channels 115. The threshold may be configured to prevent slippage, wobbling or undesirable movement of the gears within the housing 116.

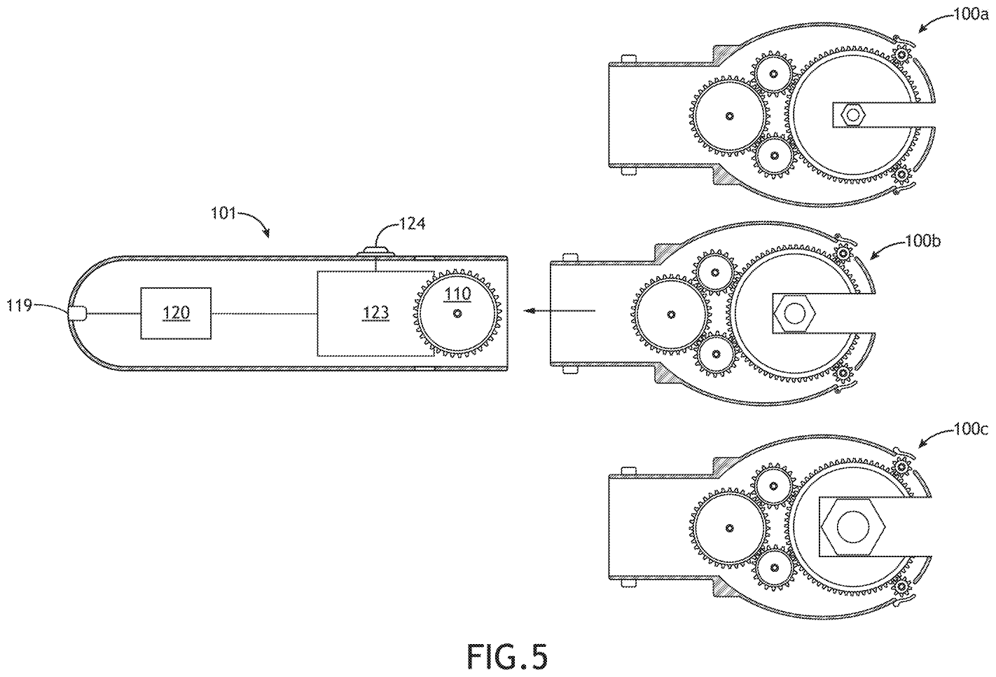

FIG. 5 illustrates a motorized adjustable wrench 100 in accordance with one or more embodiments of the present disclosure. As previously described, the wrench head 101 may be configured to be removably coupled to the handle portion 102. The motorized adjustable wrench 100 may be configured for use with a plurality of wrench heads 101, where the plurality of wrench heads 101 includes wrench heads 101 configured for adaptability to nuts 107 of different sizes. For example, as shown in FIG. 5, the motorized adjustable wrench 100 may include a single handle portion 102 and a plurality of wrench heads 101a, 101b, and 101c, where each of the plurality of wrench heads 101a, 101b, and 101c includes an opening 106 of a different size for receipt and engagement of nuts of varying sizes.

It is noted that the embodiments of the present disclosure are not limited to a plurality of wrench heads 101 configured for adaptability to nuts 107 of different sizes. For example, though not shown, the motorized adjustable wrench may include a single handle portion 102 and a plurality of wrench heads 101, where each of the plurality of wrench heads 101 includes an opening 106 of a different shape for receipt and engagement of nuts of varying shapes.

Different features, variations, and multiple different embodiments have been shown and described with various details. What has been described in this application, at times, in terms of specific embodiments, is done for illustrative purposes only and without the intent to limit or suggest that what has been conceived is only one particular embodiment or specific embodiments. It is to be understood that this disclosure is not limited to any single specific embodiment or enumerated variation. Many modifications, variations, and other embodiments will come to the mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art, and in reliance upon the complete disclosure present at the time of filing.

1. A motorized adjustable wrench, comprising:
a wrench head, including:
a geared wrench having an opening configured to receive and engage a nut; and
a geared wrench support mechanism; and
a plurality of cooperating gears in mechanical communication with the geared wrench; and
a handle portion, including:
a motor in mechanical communication with a drive gear; and
a switch.

2. The motorized adjustable wrench of claim 1, wherein
the wrench head is removably coupled to the handle portion.

3. The motorized adjustable wrench of claim 1, wherein
the handle portion includes a battery.

4. (canceled)

5. The motorized adjustable wrench of claim 1, wherein
the geared wrench support mechanism includes one or more free-wheeling gears.

6. The motorized adjustable wrench of claim 1, wherein the geared wrench support mechanism includes one or more channels in at least one of the wrench head or the handle portion.

7. The motorized adjustable wrench of claim 6, wherein
one or more pads are disposed in the one or more channels.

8. The motorized adjustable wrench of claim 1, wherein
the wrench head includes one or more hinged covers.

9. (canceled)

10. The motorized adjustable wrench of claim 1, wherein
the drive gear is configured to transfer rotational motion to the plurality of cooperating gears.

11. (canceled)

12. (canceled)

13. (canceled)

14. The motorized adjustable wrench of claim 1, further comprising
a plurality of wrench heads, wherein
each of the plurality of wrench heads is configured to receive and engage a nut of a different shape.

15. The motorized adjustable wrench of claim 1, further comprising
a plurality of wrench heads, wherein
each of the plurality of wrench heads is configured to receive and engage a nut of a different size.

16. A motorized adjustable wrench, comprising:
a plurality of wrench heads, wherein each of the plurality of wrench heads includes:
a geared wrench having an opening configured to receive and engage a nut; and
a geared wrench support mechanism; and
a plurality of cooperating gears in mechanical communication with the geared wrench; and wherein
each of the plurality of wrench heads includes a geared wrench of a different size; and
a handle portion, including:
a motor in mechanical communication with a drive gear; and
a switch.

17. The motorized adjustable wrench of claim 16, wherein
each of the plurality of wrench heads is removably coupled to the handle portion.

18. The motorized adjustable wrench of claim 16, wherein
the handle portion includes a battery.

19. (canceled)

20. The motorized adjustable wrench of claim 16, wherein
the geared wrench support mechanism includes one or more free-wheeling gears.

21. The motorized adjustable wrench of claim 16, wherein
the geared wrench support mechanism includes one or more channels in at least one of the wrench head or the handle portion.

22. The motorized adjustable wrench of claim 21, wherein
one or more pads are disposed in the one or more channels.

23. The motorized adjustable wrench of claim 16, wherein
the wrench head includes one or more hinged covers.

24. (canceled)

25. The motorized adjustable wrench of claim 16, wherein
the drive gear is configured to transfer rotational motion to the plurality of cooperating gears.

26. (canceled)

27. (canceled)

28. (canceled)

29. The motorized adjustable wrench of claim 16, further comprising, wherein
each of the plurality of wrench heads is configured to receive and engage a nut of a different shape.

30. The motorized adjustable wrench of claim 16, wherein
each of the plurality of wrench heads is configured to receive and engage a nut of a different size.
